(19) United States
(12) Patent Application Publication
(10) Pub. No.: US 2015/0005448 A1
(43) Pub. Date: Jan. 1, 2015

(54) RUBBER COMPOSITION COMPRISING A BLOCKED MERCAPTOSILANE COUPLING AGENT

(71) Applicants: COMPAGNIE GENERAL DES ETABLISSEMENTS MICHELIN, Clermont-Ferrand (FR); MICHELIN RECHERCHE ET TECHNIQUES S.A., Granges-Paccot (CH)

(72) Inventors: Karine Longchambon, Clermont-Ferrand (FR); José Carlos Araujo Da Silva, Clermont-Ferrand (FR); Nicolas Seeboth, Clermont-Ferrand (FR)

(21) Appl. No.: 14/365,688

(22) PCT Filed: Dec. 12, 2012
(86) PCT No.: PCT/EP2012/075229

§ 371 Date: Jun. 16, 2014

(30) Foreign Application Priority Data
Dec. 16, 2011 (FR) 1161785

(51) Int. Cl. C08C 19/25

(52) U.S. Cl. CPC C08C 19/25
USPC 525/102

(57) ABSTRACT

A rubber composition, devoid of zinc or comprising less than 0.5 phr of zinc and devoid of guanidine derivatives or comprising less than 0.5 phr of guanidine derivatives, based on at least one diene elastomer, one inorganic filler as reinforcing filler and one blocked mercaptosilane corresponding to the formula:

(R²O)ₐR¹₍₃₋ₐ₎Si—Z—S—C(═O)-A
wherein:
   R¹, which are identical or different, each represent a monovalent hydrocarbon group chosen from linear or branched alkyls, cycloalkyls or aryls having from 1 to 18 carbon atoms;
   R², which are identical or different, each represent hydrogen or a monovalent hydrocarbon group chosen from linear or branched alkyls, cycloalkyls or aryls having from 1 to 18 carbon atoms;
   A represents hydrogen or a monovalent hydrocarbon group chosen from linear or branched alkyls, cycloalkyls or aryls having from 1 to 18 carbon atoms and linear or branched alkoxyalkyls having from 2 to 8 carbon atoms;
   Z represents a divalent bonding group comprising from 1 to 18 carbon atoms;
   a is an integer equal to 1, 2 or 3.

This application is a 371 national phase entry of PCT/EP2012/075229, filed 12 Dec. 2012, which claims benefit of FR 1161785, filed 16 Dec. 2011, the entire contents of which are incorporated herein by reference for all purposes.

### BACKGROUND

1. Field

The present disclosure relates to diene rubber compositions reinforced with an inorganic filler, such as silica, which can be used in particular for the manufacture of tires or semi-finished products for tires, such as treads.

2. Description of Related Art

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer.

The term “coupling agent” is understood to mean, in a known way, an agent capable of establishing a satisfactory bond, of chemical and/or physical nature, between the inorganic filler and the diene elastomer; such an at least bifunctional coupling agent has, for example, the simplified general formula “Y—Z—X”, in which:
Y represents a functional group (“Y” functional group) which is capable of being bonded physically and/or chemically to the inorganic filler, it being possible for such a bond to be established, for example, between a silicon atom of the coupling agent and the surface hydroxyl (OH) groups of the inorganic filler (for example the surface silanols, when silica is concerned);
X represents a functional group (“X” functional group) which is capable of being bonded physically and/or chemically to the diene elastomer, for example via a sulphur atom;
Z represents a divalent group which makes it possible to connect Y and X.

Coupling agents, in particular silica/diene elastomer coupling agents, have been described in a very large number of documents, the most well-known being bifunctional organosilanes bearing alkoxy functional groups (that is to say, by definition, “alkoxysilanes”) as “Y” functional groups and, as “X” functional groups, functional groups capable of reacting with the diene elastomer, such as, for example, polysulphide functional groups.

Among the many existing coupling agents, mercaptosilanes prove to be particularly advantageous; however, given their very high reactivity, blocked mercaptosilanes are generally used.

It should be remembered here that blocked mercaptosilanes, in a way well-known to a person skilled in the art, are silane precursors capable of forming mercaptosilanes during the preparation of the rubber compositions (see, for example, US 2002/0115767 A1 or International Application WO 02/48256). The molecules of these silane precursors, hereinafter referred to as blocked mercaptosilanes, have a blocking group instead of the hydrogen atom of the corresponding mercaptosilane. The blocked mercaptosilanes are capable of being deblocked by replacement of the blocking group by a hydrogen atom, during the compounding and curing, in order to result in the formation of a more reactive mercaptosilane, defined as a silane having a molecular structure which comprises at least one thiol (—SH) (mercapto-) group bonded to a carbon atom and at least one silicon atom. These blocked mercaptosilane coupling agents are thus generally used in the presence of a blocked mercaptosilane activator, the role of which is to initiate, accelerate or amplify the activity of the blocked mercaptosilane, as is specified in particular in U.S. Pat. No. 7,122,590.

Such an activator or “deblocking agent” for tire rubber compositions is generally composed of a guanidine, in particular N,N′-diphenylguanidine, DPG.

### SUMMARY

The Applicant has discovered, surprisingly, that rubber compositions comprising, as coupling agent, specific blocked mercaptosilanes, simultaneously devoid or virtually devoid of guanidine derivatives and devoid or virtually devoid of zinc oxide, make it possible to obtain a similar compromise in properties to that obtained with the same mercaptosilanes in the presence of guanidine derivatives and zinc oxide.

The term “guanidine derivatives” is understood to mean the organic compounds bearing a guanidine functional group as main functional group, such as those known in tire compositions, in particular as vulcanization accelerators, for example diphenylguanidine (DPG) or di(ortho-tolyl)guanidine (DOTG).

It should be noted that the vulcanization of diene elastomers by sulphur is widely used in the rubber industry, in particular in the tire industry. In order to vulcanize diene elastomers, use is made of a relatively complex vulcanization system comprising, in addition to the sulphur, various vulcanization accelerators and also one or more vulcanization activators, very particularly zinc derivatives, such as zinc oxide (ZnO) or zinc salts of fatty acids, such as zinc stearate.

A medium-term objective of tire manufacturers is to eliminate zinc or its derivatives from their rubber formulations, due to the known relatively toxic nature of these compounds, in particular with respect to water and aquatic organisms (classification R50 according to European Directive 67/548/EC of 9 Dec. 1996).

However, it is found that the elimination of zinc oxide, specifically from rubber compositions reinforced with an organic filler, such as silica, is very highly damaging to the processing characteristics (“processability”) of rubber compositions in the raw state, with a reduction in the scorch time which is absolutely unacceptable from the industrial viewpoint. It should be remembered that the “scorching” phenomenon rapidly results, during the preparation of the rubber competitions in a mixer, in premature vulcanizations (“scorching”), in very high viscosities in the raw state, finally in rubber compositions which are virtually impossible to work and to process industrially.

Thus, the combination of these negligible, indeed even nonexistent, amounts of guanidine derivatives and zinc oxide in compositions comprising silica and specific blocked mercaptosilanes as coupling agent makes it possible, surprisingly, for the coupling agent to react without requiring the presence of a deblocking agent and without a deterioration in the properties of this composition.

A subject-matter of the invention is thus a rubber composition, devoid of zinc or comprising less than 0.5 part per hundred parts of elastomer, phr, of zinc and devoid of guanidine derivatives or comprising less than or 0.5 phr of guanidine derivatives, based on at least one diene elastomer, one inorganic filler as reinforcing filler and one blocked mercaptosilane corresponding to the general formula (I):

(R²O)ₐR¹₍₃₋ₐ₎Si—Z—S—C(═O)-A
in which:
   the symbols R¹, which are identical or different, each represent a monovalent hydrocarbon group chosen from linear or branched alkyls, cycloalkyls or aryls having from 1 to 18 carbon atoms;
   the symbols R², which are identical or different, each represent hydrogen or a monovalent hydrocarbon group chosen from linear or branched alkyls, cycloalkyls or aryls having from 1 to 18 carbon atoms;
   the symbol A represents hydrogen or a monovalent hydrocarbon group chosen from linear or branched alkyls, cycloalkyls or aryls having from 1 to 18 carbon atoms and linear or branched alkoxyalkyls having from 2 to 8 carbon atoms;
   the symbol Z represents a divalent bonding group comprising from 1 to 18 carbon atoms;
   a is an integer equal to 1, 2 or 3.

A further subject-matter of the invention is a finished or semi-finished article comprising such a composition, in particular a tire tread.

Another subject-matter of the invention is a tire or semi-finished product comprising at least one composition as mentioned above.

### DETAILED DESCRIPTION OF SPECIFIC EMBODIMENTS

### I. Measurements and Tests Used

The rubber compositions in which the coupling agents are tested are characterized, before and after curing, as indicated below.

### I-1. Tensile Tests

These tensile tests make it possible to determine the elasticity stresses and the properties at break. Unless otherwise indicated, they are carried out in accordance with French Standard NF T 46-002 of September 1988. The nominal secant modulus (or apparent stress, in MPa) is measured in second elongation (i.e. after an accommodation cycle at the extension rate provided for the measurement itself) at 100% elongation (denoted M100) and 300% elongation (M300).

### I-2. Dynamic Properties

The dynamic properties ΔG* and tan(δ)ₘₐₓ are measured on a viscosity analyser (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, at 23° C., is recorded. A strain amplitude sweep is carried out from 0.1% to 50% (outward cycle) and then from 50% to 1% (return cycle). The results made use of are the complex dynamic shear modulus (G*) and the loss factor (tan δ). The maximum value of tan δ observed (tan(δ)ₘₐₓ) and the difference in complex modulus (ΔG*) between the values at 0.1% and at 50% strain (Payne effect) are shown for the return cycle.

### II. Detailed Description of the Invention

The compositions of the invention are thus devoid of zinc or comprise less than 0.5 part per hundred parts of elastomer, phr, of zinc and devoid of guanidine derivatives or comprise less than or 0.5 phr of guanidine derivatives, based on at least one diene elastomer (phr=parts per hundred parts of elastomer, by weight), one inorganic filler as reinforcing filler and one blocked mercaptosilane corresponding to the general formula (I).

The expression “composition based on” should be understood as meaning, in the present patent application, a composition comprising the mixture and/or the reaction product of the various constituents used, some of these base constituents (for example, the coupling agent) being capable of reacting or intended to react with one another, at least in part, during the various phases of manufacture of the compositions, in particular during their vulcanization (curing).

In the present description, unless expressly indicated otherwise, all the percentages (%) shown are % by weight.

### II-1. Diene Elastomer

“Diene” elastomer or rubber is understood to mean, in a general way, an elastomer resulting at least in part (i.e., a homopolymer or a copolymer) from diene monomers (monomers bearing two conjugated or non-conjugated carbon-carbon double bonds).

Diene elastomers, in a known way, can be classified into two categories: those said to be “essentially unsaturated” and those said to be “essentially saturated”. “Essentially unsaturated” diene elastomer is understood to mean a diene elastomer resulting at least in part from conjugated diene monomers having a content of units of diene origin (conjugated dienes) which is greater than 15% (mol %). Thus it is, for example, that diene elastomers such as butyl rubbers or copolymers of dienes and of α-olefins of EPDM type do not come within this definition and can be described, on the contrary, as “essentially saturated” diene elastomers (low or very low content of units of diene origin, always less than 15%). In the category of “essentially unsaturated” diene elastomers, “highly unsaturated” diene elastomer is understood to mean in particular a diene elastomer having a content of units of diene origin (conjugated dienes) which is greater than 50%.

Given these definitions, diene elastomer capable of being used in the compositions in accordance with the invention is understood more particularly to mean:
(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, a person skilled in the art of tires will understand that the present invention is preferably employed with essentially unsaturated diene elastomers, in particular of the above type (a) or (b).

The following are suitable in particular as conjugated dienes: 1,3-butadiene, 2-methyl-1,3-butadiene, 2,3-di((C₁-C₅)alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be block, statistical, sequential or microsequential elastomers and can be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

The following are suitable: polybutadienes, in particular those having a content (mol %) of 1,2-units of between 4% and 80% or those having a content (mol %) of cis-1,4-units of greater than 80%, polyisoprenes, butadiene/styrene copolymers and in particular those having a Tg (glass transition temperature (Tg, measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers, in particular those having an isoprene content of between 5% and 90% by weight and a Tg of −40° C. to −80° C., or isoprene/styrene copolymers, in particular those having a styrene content of between 5% and 50% by weight and a Tg of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly to between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2- plus 3,4-units of the isoprene part of between 5% and 70% and a content (mol %) of trans-1,4-units of the isoprene part of between 10% and 50%, and more generally any butadiene/styrene/isoprene copolymer having a Tg of between −20° C. and −70° C., are suitable in particular.

To summarize, particularly preferably, the diene elastomer of the composition in accordance with the invention is selected from the group of (highly unsaturated) diene elastomers consisting of polybutadienes (BRs), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and the mixtures of such copolymers.

According to a specific embodiment, the diene elastomer is predominantly (i.e., for more than 50 phr) an SBR, whether an SBR prepared in emulsion (“ESBR”) or an SBR prepared in solution (“SSBR”), or an SBR/BR, SBR/NR (or SBR/IR), BR/NR (or BR/IR) or also SBR/BR/NR (or SBR/BR/IR) blend (mixture). In the case of an SBR (ESBR or SSBR) elastomer, use is made in particular of an SBR having a moderate styrene content, for example of between 20% and 35% by weight, or a high styrene content, for example from 35% to 45%, a content of vinyl bonds of the butadiene part of between 15% and 70%, a content (mol %) of trans-1,4-bonds of between 15% and 75% and a Tg of between −10° C. and −55° C.; such an SBR can advantageously be used as a mixture with a BR preferably having more than 90% (mol %) of cis-1,4-bonds.

According to another specific embodiment, the diene elastomer is predominantly (for more than 50 phr) an isoprene elastomer. This is in particular the case when the compositions of the invention are intended to constitute, in the tires, rubber matrices of certain treads (for example for industrial vehicles), of crown reinforcing plies (for example of working plies, protection plies or hooping plies), of carcass reinforcing plies, of sidewalls, of beads, of protectors, of underlayers, of rubber blocks and other internal rubbers providing the interface between the abovementioned regions of the tires.

“Isoprene elastomer” is understood to mean, in a known way, an isoprene homopolymer or copolymer, in other words a diene elastomer selected from the group consisting of natural rubber (NR), synthetic polyisoprenes (IRs), various isoprene copolymers and the mixtures of these elastomers. Mention will in particular be made, among isoprene copolymers, of isobutene/isoprene (butyl rubber—IIR), isoprene/styrene (SIR), isoprene/butadiene (BIR) or isoprene/butadiene/styrene (SBIR) copolymers. This isoprene elastomer is preferably natural rubber or a synthetic cis-1,4-polyisoprene; use is preferably made, among these synthetic polyisoprenes, of polyisoprenes having a content (mol %) of cis-1,4-bonds of greater than 90%, more preferentially still of greater than 98%.

According to another specific embodiment, in particular when it is intended for a tire sidewall or for an airtight inner liner of a tubeless tire (or other air-impermeable component), the composition in accordance with the invention can comprise at least one essentially saturated diene elastomer, in particular at least one EPDM copolymer or one butyl rubber (optionally chlorinated or brominated), whether these copolymers are used alone or as a mixture with highly unsaturated diene elastomers as mentioned above, in particular NR or IRs, BRs or SBRs.

According to another preferred embodiment of the invention, the rubber composition comprises a blend of a (one or more) “high Tg” diene elastomer exhibiting a Tg of between −70° C. and 0° C. and of a (one or more) “low Tg” diene elastomer of between −110° C. and −80° C., more preferably between −105° C. and −90° C. The high Tg elastomer is preferably selected from the group consisting of S-SBRs, E-SBRs, natural rubber, synthetic polyisoprenes (exhibiting a content (mol %) of cis-1,4-enchainments preferably of greater than 95%), BIRs, SIRs, SBIRs, and the mixtures of these elastomers. The low Tg elastomer preferably comprises butadiene units according to a content (mol %) at least equal to 70%; it preferably consists of a polybutadiene (BR) exhibiting a content (mol %) of cis-1,4-enchainments of greater than 90%.

According to another specific embodiment of the invention, the rubber composition comprises, for example, from 30 to 100 phr, in particular from 50 to 100 phr, of a high Tg elastomer as a blend with from 0 to 70 phr, in particular from 0 to 50 phr, of a low Tg elastomer; according to another example, it comprises, for the totality of the 100 phr, one or more SBRs prepared in solution.

According to another specific embodiment of the invention, the diene elastomer of the composition according to the invention comprises a blend of a BR (as low Tg elastomer) exhibiting a content (mol %) of cis-1,4-enchainments of greater than 90% with one or more S-SBRs or E-SBRs (as high Tg elastomer(s)).

The compositions of the invention can comprise just one diene elastomer or a mixture of several diene elastomers, it being possible for the diene elastomer or elastomers to be used in combination with any type of synthetic elastomer other than a diene elastomer, indeed even with polymers other than elastomers, for example thermoplastic polymers.

### II-2. Reinforcing Inorganic Filler

The term “reinforcing inorganic filler” should be understood here as meaning, in a known way, any inorganic or mineral filler, whatever its colour and its origin (natural or synthetic), also known as “white filler”, “clear filler” or also “non-black filler”, in contrast to carbon black, this inorganic filler being capable of reinforcing, by itself alone, without means other than an intermediate coupling agent, a rubber composition intended for the manufacture of a tread for tires, in other words capable of replacing, in its reinforcing role, a conventional tire-grade carbon black, in particular for a tread; such a filler is generally characterized, in a known way, by the presence of hydroxyl (—OH) groups at its surface.

Preferably, the reinforcing inorganic filler is a filler of the siliceous or aluminous type, or a mixture of these two types of fillers.

The silica (SiO₂) used can be any reinforcing silica known to a person skilled in the art, in particular any precipitated or fumed silica exhibiting a BET specific surface and a CTAB specific surface both of less than 450 m²/g, preferably from 30 to 400 m²/g. Highly dispersible precipitated silicas (HDSs) are preferred, in particular when the invention is employed in the manufacture of tires exhibiting a low rolling resistance; mention may be made, as examples of such silicas, of the Ultrasil 7000 silicas from Degussa, the Zeosil 1165 MP, 1135 MP and 1115 MP silicas from Rhodia, the Hi-Sil EZ150G silica from PPG or the Zeopol 8715, 8745 and 8755 silicas from Huber.

The reinforcing alumina (Al₂O₃) preferably used is a highly dispersible alumina having a BET specific surface ranging from 30 to 400 m²/g, more preferably between 60 and 250 m²/g, and a mean particle size at most equal to 500 nm, more preferably at most equal to 200 nm. Mention may in particular be made, as non-limiting examples of such reinforcing aluminas, of the Baikalox A125 or CR125 alumina (Baikowski), APA-100RDX alumina (Condea), Aluminoxid C alumina (Degussa) or AKP-G015 alumina (Sumitomo Chemicals).

Mention may also be made, as other examples of inorganic filler capable of being used in the rubber compositions of the treads of the invention, of aluminium (oxide) hydroxides, aluminosilicates, titanium oxides, silicon carbides or nitrides, all of the reinforcing type as described, for example, in Applications WO 99/28376, WO 00/73372, WO 02/053634, WO 2004/003067 and WO 2004/056915.

When the treads of the invention are intended for tires having a low rolling resistance, the reinforcing inorganic filler used, in particular if it is silica, preferably has a BET specific surface of between 60 and 350 m²/g. An advantageous embodiment of the invention consists in using a reinforcing inorganic filler, in particular a silica, having a high BET specific surface within a range from 130 to 300 m²/g, due to the high reinforcing power recognized for such fillers. According to another preferred embodiment of the invention, use may be made of a reinforcing inorganic filler, in particular a silica, exhibiting a BET specific surface of less than 130 m²/g, preferably, in such a case, between 60 and 130 m²/g (see, for example, Applications WO03/002648 and WO03/002649).

The physical state under which the reinforcing inorganic filler is provided is not important, whether it is in the form of a powder, of microbeads, of granules, of beads or any other appropriate densified form. Of course, the term “reinforcing inorganic filler” is also understood to mean mixtures of different reinforcing inorganic fillers, in particular of highly dispersible siliceous and/or aluminous fillers as described above.

A person skilled in the art will know how to adjust the content of reinforcing inorganic filler according to the nature of the inorganic filler used and according to the type of tire concerned, for example tire for a motorbike, for a passenger vehicle or for a utility vehicle, such as a lorry or heavy duty vehicle. Preferably, this content of reinforcing inorganic filler will be chosen between 20 and 200 phr, more preferably between 30 and 150 phr, in particular greater than 50 phr, and more preferably still between 60 and 140 phr.

In the present account, the BET specific surface is determined, in a known way, by gas adsorption using the Brunauer-Emmett-Teller method described in “The Journal of the American Chemical Society”, Vol. 60, page 309, February 1938, more specifically according to French Standard NF ISO 9277 of December 1996 (multipoint (5 points) volumetric method—gas: nitrogen—degassing: 1 hour at 160° C.—relative pressure range p/po: 0.05 to 0.17). The CTAB specific surface is the external surface determined according to French Standard NF T 45-007 of November 1987 (method B).

Finally, a person skilled in the art will understand that, as filler equivalent to the reinforcing inorganic filler described in the present section, use might be made of a reinforcing filler of another nature, in particular organic nature, provided that this reinforcing filler is covered with an inorganic layer, such as silica, or else comprises functional sites, in particular hydroxyl sites, at its surface which require the use of a coupling agent in order to form the bond between the filler and the elastomer. Mention may be made, as examples of such organic fillers, of functionalized polyvinylaromatic organic fillers, such as described in Applications WO 2006/069792 and WO 2006/069793.

The reinforcing inorganic filler can also be used in combination with an organic reinforcing filler, in particular carbon black, for example a black of the HAF, ISAF or SAF type, conventionally used in tires and in particular in tire treads (for example, N115, N134, N234, N326, N330, N339, N347 or N375 blacks or also, depending on the applications targeted, blacks of higher series, for example N660, N683 or N772). These carbon blacks can be used in the isolated state, as available commercially, or in any other form, for example as support for some of the rubber additives used. The carbon blacks might, for example, be already incorporated in the elastomer in the form of a masterbatch (see, for example, Applications WO 97/36724 or WO 99/16600).

The amount of carbon black present in the total reinforcing filler can vary within wide limits; however, the reinforcing inorganic filler is preferably the predominant reinforcing filler. Advantageously, carbon black is used in a very small proportion, at a content preferably of less than 10 phr. Within the intervals indicated, benefit is derived from the colouring (black pigmenting agent) and UV-inhibiting properties of carbon blacks, furthermore without damaging the typical performance contributed by the reinforcing inorganic filler. Of course, the composition of the invention can be completely devoid of carbon black.

### II-3. Blocked Mercaptosilane

Use is made of a blocked mercaptosilane of general formula (I):

(R²O)ₐR¹₍₃₋ₐ₎Si—Z—S—C(═O)-A
in which:
   the symbols R¹, which are identical or different, each represent a monovalent hydrocarbon group chosen from linear or branched alkyls, cycloalkyls or aryls having from 1 to 18 carbon atoms;
   the symbols R², which are identical or different, each represent hydrogen or a monovalent hydrocarbon group chosen from linear or branched alkyls, cycloalkyls or aryls having from 1 to 18 carbon atoms;
   the symbol A represents hydrogen or a monovalent hydrocarbon group chosen from linear or branched alkyls, cycloalkyls or aryls having from 1 to 18 carbon atoms and linear or branched alkoxyalkyls having from 2 to 8 carbon atoms;
   the symbol Z represents a divalent bonding group comprising from 1 to 18 carbon atoms;
   a is an integer equal to 1, 2 or 3.

Z can comprise one or more heteroatoms chosen from O, S and N.

According to a first preferred embodiment, a is equal to 3 and at least one of the R² symbols represents a monovalent hydrocarbon group chosen from linear or branched alkyls, cycloalkyls or aryls having from 1 to 18 carbon atoms.

According to a second embodiment of the invention, the R² symbols represent a monovalent hydrocarbon group chosen from linear or branched alkyls, cycloalkyls or aryls having from 1 to 18 carbon atoms.

According to a preferred alternative form of this second embodiment, the following characteristics are adhered to:
the R¹ and R² symbols are chosen from methyl, ethyl, n-propyl and isopropyl, preferably from methyl and ethyl;
the A symbol is chosen from alkyls having from 1 to 18 carbon atoms and the phenyl radical;
the Z symbol is chosen from C₁-C₁₈ alkylenes and C₆-C₁₂ arylenes.

More preferably, Z is chosen from methylene, ethylene or propylene, more particularly propylene. In particular, R¹ and R² are ethyls, A is a heptyl and Z is a propylene. Mention will in particular be made of S-octanoylmercaptopropyltriethoxysilane.

According to another preferred alternative form of this second embodiment of the invention, a is equal to 1. Preferably:
the R¹ symbols are chosen from methyl, ethyl, n-propyl and isopropyl, preferably from methyl and ethyl;
R² is chosen from methyl and ethyl,
A is chosen from alkyls having from 1 to 18 carbon atoms and the phenyl radical,
Z is chosen from C₁-C₁₈ alkylenes and C₆-C₁₂ arylenes.

More preferably, Z is chosen from C₁-C₁₀ alkylenes and more preferably still Z is chosen from C₁-C₄ alkylenes.

In particular, the R¹ symbols are methyls; more particularly, A is chosen from alkyls having from 1 to 7 carbon atoms and the phenyl radical.

More preferably still, the R¹ symbols are methyls, A is a heptyl, R² is an ethyl and Z is a propylene.

S-Octanoylmercaptopropylethoxydimethylsilane is particularly suitable.

According to a third preferred embodiment of the invention, the blocked mercaptosilanes of formula (I) are such that the R² symbol represents hydrogen.

Preferably, a is equal to 2 or to 1 and preferably:
R¹ is chosen from methyl, ethyl, n-propyl and isopropyl, preferably from methyl and ethyl;
A is chosen from alkyls having from 1 to 18 carbon atoms and the phenyl radical;
Z is chosen from C₁-C₁₈ alkylenes and C₆-C₁₂ arylenes.

According to a preferred alternative form, Z is chosen from C₁-C₁₀ alkylenes and more particularly Z is chosen from C₁-C₄ alkylenes.

Preferably, R¹ is a methyl and preferably A is chosen from alkyls having from 1 to 7 carbon atoms and the phenyl radical; in particular, R¹ is a methyl, Z is a propylene and A is a heptyl.

By way of example, S-octanoylmercaptopropylhydroxydimethylsilane and S-octanoylmercaptopropyldihydroxymethylsilane are particularly suitable.

A person skilled in the art will know how to adjust the content of blocked mercaptosilane of formula (I) as a function of the specific embodiments of the invention, in particular of the amount of reinforcing inorganic filler used, the preferred content representing between 2% and 20% by weight, with respect to the amount of reinforcing inorganic filler; contents of less than 15% are more particularly preferred.

In view of the amounts expressed above, generally, the content of blocked mercaptosilane is preferably between 2 and 15 phr. Below the minima indicated, the risk exists of the effect being insufficient whereas, above the recommended maximum, no more improvement is generally observed, while the costs of the composition increase; for these different reasons, this content is more preferably still between 4 and 12 phr.

### II-4. Various Additives

The rubber compositions in accordance with the invention can also comprise all or a portion of the usual additives generally used in elastomer compositions intended for the manufacture of tires, in particular of treads, such as, for example, plasticizers or extending oils, whether the latter are aromatic or non-aromatic in nature, pigments, protective agents, such as antiozone waxes, chemical antiozonants or antioxidants, anti-fatigue agents, reinforcing resins, methylene acceptors (for example, phenolic novolak resin) or methylene donors (for example, HMT or H3M), such as described, for example, in Application WO 02/10269, a crosslinking system based either on sulphur or on sulphur donors and/or on peroxide and/or on bismaleimides, vulcanization accelerators or vulcanization activators, with the exception, of course, of zinc-based activators (or in accordance with the 0.5 phr maximum for zinc in the composition, and preferably less than 0.3 phr).

Preferably, these compositions comprise, as preferred non-aromatic or very weakly aromatic plasticizing agent, at least one compound selected from the group consisting of naphthenic oils, paraffinic oils, MES oils, TDAE oils, glycerol esters (in particular trioleates), plasticizing hydrocarbon resins exhibiting a high Tg preferably of greater than 30° C., and the mixtures of such compounds.

These compositions can also comprise, in addition to the coupling agents, coupling activators, covering agents (for example comprising the Y functional group alone) for the reinforcing inorganic filler or more generally processing aids capable, in a known way, by virtue of an improvement in the dispersion of the inorganic filler in the rubber matrix and of a lowering in the viscosity of the compositions, of improving their ease of processing in the raw state, these processing aids being, for example, hydrolysable silanes, such as alkylalkoxysilanes (in particular alkyltriethoxysilanes), polyols, polyethers (for example, polyethylene glycols), primary, secondary or tertiary amines (for example, trialkanolamines), hydroxylated or hydrolysable POSs, for example α,ω-dihydroxypolyorganosiloxanes (in particular α,ω-dihydroxypolydimethylsiloxanes), or fatty acids, such as, for example, stearic acid.

### II-5. Manufacture of the Rubber Compositions

The rubber compositions of the invention are manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking or vulcanization system is incorporated.

According to a preferred embodiment of the invention, all the base constituents of the compositions of the invention, with the exception of the vulcanization system, namely the reinforcing inorganic filler, the coupling agent of formula (I) and the carbon black, are intimately incorporated, by kneading, in the diene elastomer during the first “non-productive” phase, that is to say that at least these various base constituents are introduced into the mixer and are thermomechanically kneaded, in one or more stages, until the maximum temperature of between 130° C. and 200° C., preferably of between 145° C. and 185° C., is reached.

By way of example, the first (non-productive) phase is carried out in a single thermomechanical stage during which all the necessary constituents, the optional supplementary covering agents or processing aids and various other additives, with the exception of the vulcanization system, are introduced into an appropriate mixer, such as an ordinary internal mixer. The total duration of the kneading, in this non-productive phase, is preferably between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

When a covering agent is used, its incorporation can be carried out entirely during the non-productive phase, at the same time as the inorganic filler, or else entirely during the productive phase, at the same time as the vulcanization system, or also split up over the two successive phases.

It should be noted that it is possible to introduce all or a portion of the covering agent in a form supported (placing on the support being carried out beforehand) on a solid compatible with the chemical structures corresponding to this compound. For example, when splitting up between the two successive phases above, it can be advantageous to introduce the second portion of the covering agent, onto the external mixer, after placing on a support in order to facilitate the incorporation and the dispersion thereof.

The vulcanization system proper is preferably based on sulphur and on a primary vulcanization accelerator, in particular on an accelerator of the sulphenamide type. Additional to this vulcanization system can be various known secondary vulcanization accelerators or vulcanization activators, with the exception of zinc and any zinc derivative, such as ZnO, or while observing a zinc content of the composition of less than 0.5 phr and preferably of less than 0.3 phr, such as, for example, fatty acids, such as stearic acid, guanidine derivatives (in particular diphenylguanidine), while observing a zinc content of the composition of less than 0.5 phr and preferably of less than 0.3 phr, and the like, incorporated during the first non-productive phase and/or during the productive phase.

The sulphur content is preferably between 0.5 and 3.0 phr and the primary accelerator content is preferably between 0.5 and 5.0 phr.

The final composition thus obtained is subsequently calendered, for example in the form of a sheet or a plaque, in particular for laboratory characterization, or else extruded in the form of a rubber profiled element which can be used, for example, as a tire tread for a passenger vehicle.

The vulcanization (or curing) is carried out in a known way at a temperature generally of between 130° C. and 200° C., for a sufficient time which can vary, for example, between 5 and 90 min, as a function in particular of the curing temperature, of the vulcanization system adopted and of the kinetics of vulcanization of the composition under consideration.

The invention relates to the rubber compositions described above, both in the “raw” state (i.e., before curing) and in the “cured” or vulcanized state (i.e., after crosslinking or vulcanization). The compositions in accordance with the invention can be used alone or as a blend (i.e., as a mixture) with any other rubber composition which can be used for the manufacture of tires.

### III—Examples of the Implementation of the Invention

### III-1 Blocked Mercaptosilanes Used

### III-1.1 Silane NXT (Mercaptosilane “M1”)

It should be remembered that Silane NXT is S-octanoylmercaptopropyltriethoxysilane having the expanded formula (Et=ethyl):

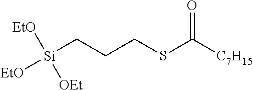

Use is made, in the examples, of the S-octanoylmercaptopropyltriethoxysilane sold under the name “Silane NXT™” by GE Silicones.

### III-1.2 S-Octanoylmercaptopropylhydroxydimethylsilane (Mercaptosilane “M2”)

One of the blocked mercaptosilanes employed in the tests which follow is S-octanoylmercaptopropylhydroxydimethylsilane, of formula:

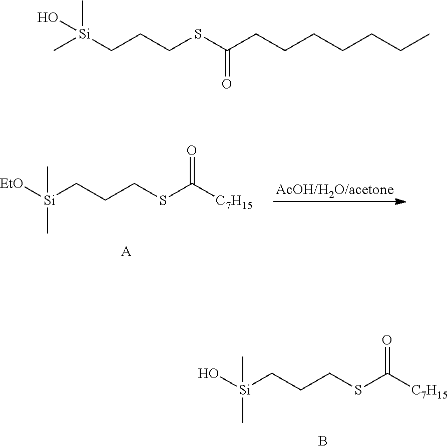

The preparation of S-octanoylmercaptopropylethoxydimethylsilane A having the CAS number [1024594-66-8] is described in the Michelin Patent Application FR 2 940 301/WO 2010072682.

The product B is prepared by hydrolysis in a catalytic acidic medium.

S-Octanoylmercaptopropylethoxydimethylsilane A (59.0 g, 0.194 mol) is added to a mixture of 1% acetic acid, demineralized water (60 ml) and acetone (300 ml). The solution is stirred at ambient temperature for 1.5-2 hours. After evaporation of the solvents at 20-23° C. under reduced pressure, the mixture obtained is chromatographed on a silica column (eluent mixture of petroleum ether and ethyl acetate in a 1:1 ratio). After evaporation of the solvents at 20-24° C. under reduced pressure, an oil (41 g, 0.148 mol, yield of 76%) is obtained.

The NMR analysis confirms the structure of the S-octanoylmercaptopropylhydroxydimethylsilane obtained with a molar purity of greater than 97%.

The NMR analysis is carried out in d₆-acetone.

Calibration: 1.98 ppm with regard to the residual ¹H signal of the acetone and 29.8 ppm with regard to the signal of the ¹³C.

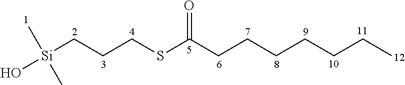

| Atom | δ ¹H (ppm) | δ ¹³C (ppm) |
|---|---|---|
| 1 | −0.01 | −0.3 |
| 2 | 0.56 | 17.9 |
| 3 | 1.55 | 24.5 |
| 4 | 2.80 | 32.2 |
| 5 | — | 198.7 |
| 6 | 2.48 | 44.2 |
| 7 | 1.55 | 26.0 |
| 8 | 1.18 → 1.29 | 29.3 |
| 9 | 1.18 → 1.29 | 31.3 |
| 10 | 1.18 → 1.29 | 32.0 |
| 11 | 1.18 → 1.29 | 23.0 |
| 12 | 0.81 | 14.0 |
| OH | ~4.30 | — |

Chemical shift ²⁹Si: 16.3 ppm (calibration with respect to the TMS)

### III-1.3 S-Octanoylmercaptopropyldihydroxymethylsilane (Mercaptosilane “M3”)

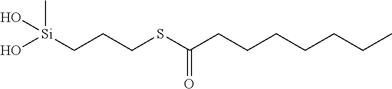 [SMILES: CCCCCCCC(=O)SCCC[Si](C)(O)O]

a) Preparation of S-octanoylmercaptopropyldimethoxymethylsilane having the CAS number [828241-23-2]:

The intermediate product G can be prepared in a two-phase medium according to the procedure described in Application WO 2005007660. Another possibility consists in preparing it according to the following procedure.

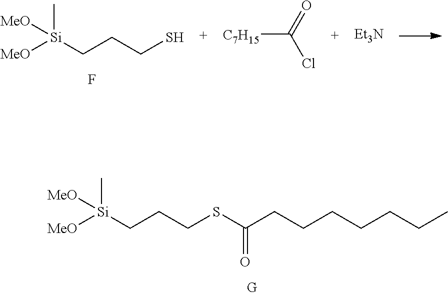

Octanoyl chloride (18.0 g, 0.111 mol) is added dropwise over 30 minutes to a solution, maintained at 5° C. under an inert atmosphere, of 3-mercaptopropyldimethoxymethylsilane F having the CAS number [31001-77-1] (20.0 g, 0.111 mol) and triethylamine (11.2 g, 0.111 mol) in cyclohexane (200 ml). The temperature of the reaction medium remains between 5 and 8° C. The reaction medium is subsequently stirred at ambient temperature for 15 hours. The triethylamine hydrochloride precipitate Et₃N*HCl is filtered off on Celite. After evaporation of the solvents at 25° C. under reduced pressure, S-octanoylmercaptopropyldimethoxymethylsilane G having the CAS number [828241-23-2] (32.6 g, 0.106 mol) is obtained in the form of a colourless oil with a yield of 96%.

The NMR analysis confirms the structure of the product obtained with a molar purity of 98%.

b) Preparation of S-octanoylmercaptopropyldihydroxymethylsilane:

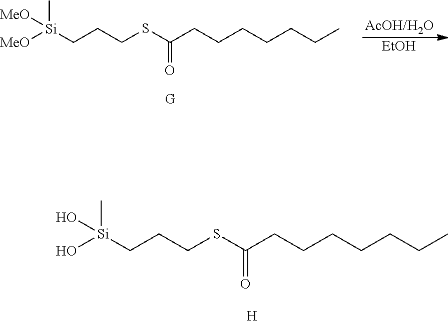

S-Octanoylmercaptopropyldimethoxymethylsilane G (42.0 g, 0.137 mol) is added to a mixture of 0.5% acetic acid, water (85 ml) and ethanol (250 ml). The solution is stirred at ambient temperature for 4 hours and then the mixture is poured onto a solution of sodium chloride (70 g) in water (1600 ml). The product is extracted with diethyl ether (two times 250 ml). After evaporation of the solvents at 15° C. under reduced pressure, the solid obtained is recrystallized from pentane (400 ml) at −20° C. for 4 to 5 hours. The crystals are filtered off and dried on a filter for 30 min and then for 2-3 h under reduced pressure.

The product obtained (24.9 g) has a melting point of 63° C. After evaporation of the filtrate at 15° C. under reduced pressure, the residue obtained is recrystallized a second time from pentane (80 ml) for 4-5 hours at −20° C. This second fraction (6.5 g) has a melting point of 63° C.

The two fractions are combined and then recrystallized from a mixture of petroleum ether (600 ml) and ethanol (10 ml) for 12 hours. After filtration and then evaporation of the residual solvents under reduced pressure for 2-3 hours, a white solid (25.8 g, 0.093 mol, yield of 68%) with a melting point of 65° C. is obtained.

The NMR analysis confirms the structure of the S-octanoylmercaptopropyldihydroxymethylsilane H obtained with a molar purity of greater than 93.5%.

If a greater purity is required, a final crystallization from a mixture of petroleum ether (500 ml) and ethanol (7 ml) for 15 hours makes it possible to obtain a solid (16.9 g, yield 44%) with a molar purity of greater than 99% (melting point 66° C.).

### III-1.4 S-Octanoylmercaptopropylethoxydimethylsilane having the CAS number

[1024594-66-8] (Mercaptosilane “M4”)

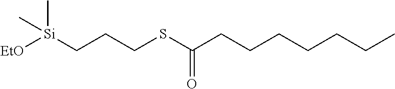 [SMILES: CCCCCCCC(=O)SCCC[Si](C)(C)OCC]

The synthesis of this compound is described in Example 10 of Patent Application FR 2 908 410 (WO 2008055986A2). No indication of purity is given for this procedure (the authors describe, however, a yellow oil, whereas the 99.5% pure product is colourless). It is possible to prepare the product by using a procedure which starts directly from the chlorosilane and not from the alkoxysilane, as described in the preceding patent application. It is possible to isolate the final product with a molar purity of 99.5%.

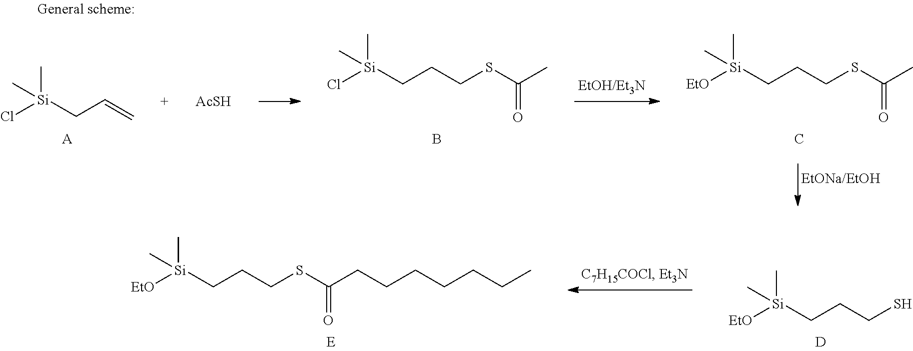

a) Synthesis of S-(ethanoyl)mercaptopropylethoxydimethylsilane C having the CAS number [1024594-63-5]

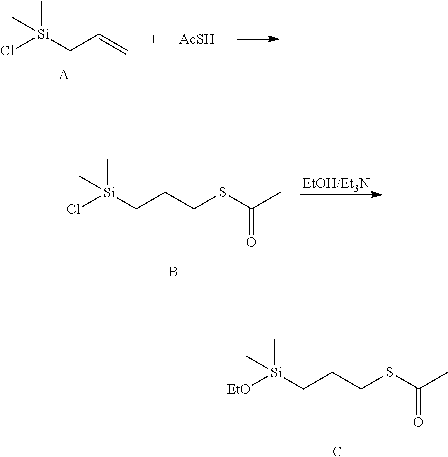

Thioacetic acid (25.5 g, 0.335 mol) is added at ambient temperature under argon to allyldimethylchlorosilane A having the CAS number [4028-23-3] (45.1 g, 0.335 mol). The reaction is exothermic. The reaction medium is stirred at 85-95° C. for 3.5 hours. After returning to ambient temperature, the non-isolated intermediate silane B is added dropwise, at 0° C. under argon over 15-20 min, to a solution of triethylamine (51.2 g, 0.506 mol) in absolute ethanol (200 ml). After stirring at ambient temperature for 15 hours, the triethylamine hydrochloride precipitate Et₃N*HCl is filtered off. After evaporation of the solvents at 40° C. under reduced pressure, the mixture obtained is redissolved in heptane (200 ml) and the Et₃N*HCl residue is removed by filtration. After evaporation of the solvents at 45° C. under reduced pressure, S-(ethanoyl)mercaptopropylethoxydimethylsilane C having the CAS number [1024594-63-5] (47.2 g, 0.215 mol) is obtained with a yield of 64%.

The NMR analysis confirms the structure of the product obtained with a molar purity of 94%.

b) Preparation of 3-mercaptopropylethoxydimethylsilane D having the CAS number [141137-15-7]:

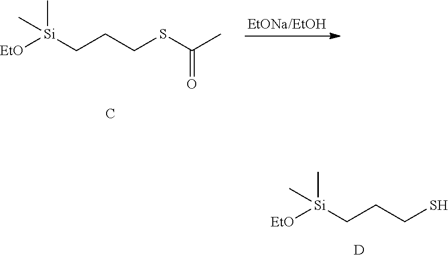

Solid sodium ethoxide (2.02 g, 0.030 mol) is added, at ambient temperature under argon, to a solution of S-(ethanoyl)mercaptopropylethoxydimethylsilane C (65.4 g, 0.297 mol) in absolute ethanol (230 ml). The reaction medium is brought to reflux for 2.5 hours. After returning to ambient temperature, the NaCl precipitate is filtered off and washed with heptane (350 ml). After evaporation of the solvents at 45° C. under reduced pressure, the oil obtained is purified by distillation under vacuum (60° C./10 mbar). 3-Mercaptopropylethoxydimethylsilane D having the CAS number [141137-15-7] (34.7 g, 0.195 mol) is obtained with a yield of 66%.

The NMR analysis confirms the structure of the product obtained with a molar purity of 99.5%.

c) Preparation of S-octanoylmercaptopropylethoxydimethylsilane E having the CAS number [1024594-66-8]

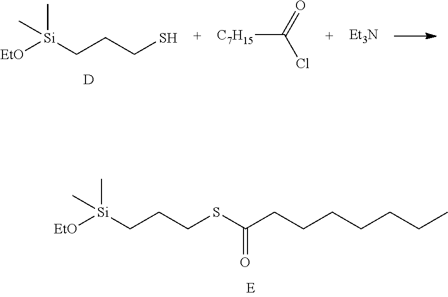

Octanoyl chloride (31.0 g, 0.191 mol) is added dropwise at 5° C. under argon over 15 minutes at 8° C. to 3-mercaptopropyldimethylethoxysilane (34.0 g, 0.191 mol) in solution in triethylamine (19.2 g, 0.191 mol) and cyclohexane (400 ml). The reaction medium is stirred at ambient temperature for 15 hours. The triethylamine hydrochloride precipitate Et₃N*HCl is filtered off. The mixture obtained is purified by flash chromatography (eluent: petroleum ether 500-600 ml). After evaporation of the solvents at 24° C. under reduced pressure, S-octanoylmercaptopropylethoxydimethylsilane E having the CAS number [1024594-66-8] (45.0 g, 0.148 mol) is obtained in the form of a colourless liquid with a yield of 78%.

The NMR analysis confirms the structure of the product obtained with a molar purity of 99.5%.

### III-2 Preparation of the Rubber Compositions

The following tests are carried out in the following way: the diene elastomer (SBR and BR blend), the silica, supplemented by a small amount of carbon black, the coupling agent and then, after kneading for one to two minutes, the various other ingredients, with the exception of the vulcanization system, are introduced into an internal mixer which is 70% filled and which has an initial vessel temperature of approximately 90° C. Thermomechanical working is then carried out (non-productive phase) in one stage (total duration of the kneading equal to approximately 5 min), until a maximum “dropping” temperature of approximately 165° C. is reached. The mixture thus obtained is recovered and cooled and then the covering agent (when the latter is present) and the vulcanization system (sulphur and sulphenamide accelerator) are added on an external mixer (homofinisher) at 70° C., everything being mixed (productive phase) for approximately 5 to 6 min.

The compositions thus obtained are subsequently calendered, either in the form of plaques (thickness of 2 to 3 mm) or thin sheets of rubber, for the measurement of their physical or mechanical properties, or in the form of profiled elements which can be used directly, after cutting and/or assembling to the desired dimensions, for example as semi-finished products for tires, in particular as tire treads.

### III-3 Characterization of the Rubber Compositions

### III-3.1 Test 1

The aim of this test is to demonstrate the improved properties of rubber compositions for tire treads having silica as reinforcing filler, which is devoid of guanidine derivatives, more specifically devoid of DPG, and devoid of zinc, comprising a blocked mercaptosilane according to the invention as coupling agent, compared, on the one hand, with a control rubber composition comprising one and the same blocked mercaptosilane and also DPG and zinc, and, on the other hand, with a control composition comprising one and the same blocked mercaptosilane and also zinc but devoid of DPG.

For this, 3 compositions based on a diene elastomer (SBR/BR blend) are prepared which are reinforced with a highly dispersible silica (HDS) and, as coupling agent, the mercaptosilane M1.

These three compositions differ essentially in the technical characteristics which follow:
the composition C1 is a control composition comprising DPG (1.5 phr) and zinc (1.5 phr of ZnO),
the composition C2 not in accordance with the invention corresponds to the composition C1 but is devoid of DPG,
the composition C3 in accordance with the invention is devoid of DPG and devoid of zinc.

Tables 1 and 2 give the formulations of the various compositions (Table 1—contents of the various products, expressed in phr or parts by weight per hundred parts of elastomer) and their properties after curing (approximately 40 min at 150° C.); the vulcanization system is composed of sulphur and sulphenamide.

The examination of the results of Table 2 shows that the composition C3 in accordance with the invention, devoid of DPG and zinc, makes it possible to have a reinforcement (M300/M100) comparable to that of the control composition C1, in contrast to the composition C2, for which the reinforcement is markedly weaker. Furthermore, surprisingly, it is found that the composition C3 in accordance with the invention exhibits a reduced hysteresis, as testified by tan(δ)ₘₐₓ and ΔG* values, compared with the control composition C1, which are substantially reduced; this is a recognized indicator of a reduction in the rolling resistance of tires and consequently of a decrease in the energy consumption of the motor vehicles equipped with such tires. In contrast, it should be noted that the composition C2, devoid only of DPG, exhibits a much greater hysteresis than the control composition C1.

### III-3.2 Test 2

The aim of this test is to demonstrate, as in Test 1, the improved properties of rubber compositions for tire treads according to the invention having silica as reinforcing filler, which is devoid of guanidine derivatives, more specifically devoid of DPG, and devoid of zinc, comprising a blocked mercaptosilane (the mercaptosilane M3) different from that of Test 1, compared, on the one hand, with a control rubber composition comprising one and the same blocked mercaptosilane and also DPG and zinc, and, on the other hand, with a control rubber composition comprising one and the same blocked mercaptosilane and also zinc but devoid of DPG.

For this, 3 compositions based on a diene elastomer (SBR/BR blend) are prepared which are reinforced with a highly dispersible silica (HDS) and, as coupling agent, the mercaptosilane M3.

These three compositions differ essentially in the technical characteristics which follow:
the composition C4 is a control composition comprising DPG (1.31 phr) and zinc (1.2 phr of ZnO),
the composition C5 not in accordance with the invention corresponds to the composition C4 but is devoid of DPG,
the composition C6 in accordance with the invention is devoid of DPG and devoid of zinc.

Tables 3 and 4 give the formulations of the various compositions (Table 3—contents of the various products, expressed in phr or parts by weight per hundred parts of elastomer) and their properties after curing (approximately 40 min at 150° C.); the vulcanization system is composed of sulphur and sulphenamide.

The examination of the results of Table 4 shows, as in Test 1, that the composition C6 in accordance with the invention, devoid of DPG and zinc, makes it possible to have a reinforcement (M300/M100) comparable to that of the control composition C4, in contrast to the composition C5, for which the reinforcement is markedly weaker. It is also found that the composition C6 in accordance with the invention exhibits a markedly reduced hysteresis (tan(δ)ₘₐₓ and ΔG* values which are substantially reduced) compared with the control composition C4; the effect appearing greater than that of the composition C5 devoid only of DPG, which exhibits a hysteresis which is also reduced with respect to the control composition C4.

### III-3.3 Test 3

The aim of this test is to demonstrate the improved properties of rubber compositions for tire treads according to the invention having silica as reinforcing filler, which is devoid of guanidine derivatives, more specifically devoid of DPG, and devoid of zinc, comprising other blocked mercaptosilanes of formula (I) (the mercaptosilanes M2 and M4), compared with a control composition conventionally comprising the commercial blocked mercaptosilane M1, DPG and zinc.

For this, 3 compositions based on a diene elastomer (SBR/BR blend) are prepared which are reinforced with a highly dispersible silica (HDS).

These three compositions differ essentially in the technical characteristics which follow:
the composition C1 is that of Test 1,
the composition C7 in accordance with the invention, devoid of DPG and zinc and comprising the mercaptosilane M2,
the composition C8 in accordance with the invention, devoid of DPG and zinc and comprising the mercaptosilane M4.

It should be noted that, in order to be able to compare the properties of the compositions C1, C7 and C8, the blocked mercaptosilane coupling agents of the compositions C7 and C8 are used at an isomolar silicon content in comparison with the control composition C1.

Tables 5 and 6 give the formulations of the various compositions (Table 5—contents of the various products, expressed in phr or parts by weight per hundred parts of elastomer) and their properties after curing (approximately 40 min at 150° C.); the vulcanization system is composed of sulphur and sulphenamide.

Table 6 emphasizes here again the fact that the compositions C7 and C8 in accordance with the invention, comprising different blocked mercaptosilanes of formula (I) and devoid of DPG and zinc, make it possible to have a reinforcement (M300/M100) comparable to that of the conventional control composition C1 comprising the blocked mercaptosilane M1 and also DPG and zinc.

TABLE 1

| | Composition No. | | |
|---|---|---|---|
| | C1 | C2 | C3 |
| SBR (1) | 70 | 70 | 70 |
| BR (2) | 30 | 30 | 30 |
| Silica (3) | 70 | 70 | 70 |
| Mercaptosilane M1 | 7.78 | 7.78 | 7.78 |
| Carbon black (4) | 3 | 3 | 3 |
| Plasticizing oil (5) | 15 | 15 | 15 |
| Plasticizing resin (6) | 8.5 | 8.5 | 8.5 |
| DPG (7) | 1.5 | — | — |
| Antiozone wax (8) | 1.5 | 1.5 | 1.5 |
| ZnO (9) | 1.5 | 1.5 | |
| Antioxidant (10) | 2 | 2 | 2 |
| Stearic acid (11) | 2 | 2 | 2 |
| Sulphur | 1 | 1 | 1 |
| Accelerator (12) | 1.6 | 1.6 | 1.6 |

```
  (1) SSBR with 41% of styrene, 41% of 1,2-polybutadiene units and 37% of trans-1,4- polybutadiene units (Tg = −12° C.);
  (2) BR (Nd) with 0.7% of 1,2-; 1.7% of trans-1,4-; 98% of cis-1,4- (Tg = −105° C.);
  (3) Silica, Zeosil 1165MP, from Rhodia in the form of microbeads (BET and CTAB: approximately 150-160 m²/g);
  (4) N234 (Degussa);
  (5) Oleic sunflower oil (Agripure 80 from Cargill);
  (6) Polylimonene resin (Resine THER 8644 from Cray Valley);
  (7) Diphenylguanidine (Perkacit DPG from Flexsys);
  (8) Mixture of macro- and microcrystalline antiozone waxes;
  (9) Zinc oxide (industrial grade—Umicore);
(10) N-(1,3-Dimethylbuty1)-N-phenyl-para-phenylenediamine (Santoflex 6-PPD from Flexsys);
(11) Stearin (Pristerene 4931—Uniqema);
(12) N-Cyclohexyl-2-benzothiazolesulphenamide (Santocure CBS from Flexsys).
```

TABLE 2

| Properties | Composition No. | | |
|---|---|---|---|
| after curing | C1 | C2 | C3 |
| M300/M100 | 1.34 | 1.17 | 1.37 |
| ΔG* (MPa) | 1.36 | 1.60 | 0.96 |
| tan(δ)ₘₐₓ | 0.239 | 0.247 | 0.232 |

TABLE 3

| | Composition No. | | |
|---|---|---|---|
| | C4 | C5 | C6 |
| SBR (1) | 70 | 70 | 70 |
| BR (2) | 30 | 30 | 30 |
| Silica (3) | 70 | 70 | 70 |
| Mercaptosilane M3 | 5.94 | 5.94 | 5.94 |
| Carbon black (4) | 3 | 3 | 3 |
| Plasticizing oil (5) | 15 | 15 | 15 |
| Plasticizing resin (6) | 8.5 | 8.5 | 8.5 |
| DPG (7) | 1.5 | — | — |
| Antiozone wax (8) | 1.5 | 1.5 | 1.5 |
| ZnO (9) | 1.5 | 1.5 | |
| Antioxidant (10) | 2 | 2 | 2 |
| Stearic acid (11) | 2 | 2 | 2 |
| Sulphur | 1 | 1 | 1 |
| Accelerator (12) | 1.6 | 1.6 | 1.6 |

TABLE 4

| Properties | Composition No. | | |
|---|---|---|---|
| after curing | C4 | C5 | C6 |
| M300/M100 | 1.21 | 1.12 | 1.32 |
| ΔG* (MPa) | 2.42 | 1.77 | 1.30 |
| tan(δ)ₘₐₓ | 0.290 | 0.270 | 0.268 |

TABLE 5

| | Composition No. | | |
|---|---|---|---|
| | C1 | C7 | C8 |
| SBR (1) | 70 | 70 | 70 |
| BR (2) | 30 | 30 | 30 |
| Silica (3) | 70 | 70 | 70 |
| Mercaptosilane M1 | 7.78 | — | — |
| Mercaptosilane M2 | — | 5.9 | — |
| Mercaptosilane M4 | — | — | 6.5 |
| Carbon black (4) | 3 | 3 | 3 |
| Plasticizing oil (5) | 15 | 15 | 16 |
| Plasticizing resin (6) | 8.5 | 8.5 | 8.5 |
| DPG (7) | 1.5 | — | — |
| Antiozone wax (8) | 1.5 | 1.5 | 1.5 |
| ZnO (9) | 1.5 | | — |
| Antioxidant (10) | 2 | 2 | 2 |
| Stearic acid (11) | 2 | 2 | 2 |
| Sulphur | 1 | 1 | 1 |
| Accelerator (12) | 1.6 | 1.6 | 1.6 |

TABLE 6

| Properties | Composition No. | | |
|---|---|---|---|
| after curing | C1 | C7 | C8 |
| M300/M100 | 1.34 | 1.26 | 1.34 |
| ΔG* (MPa) | 1.36 | 1.27 | 1.06 |

1) A rubber composition, devoid of zinc or comprising less than 0.5 part per hundred parts of elastomer, phr, of zinc and devoid of guanidine derivatives or comprising less than or 0.5 phr of guanidine derivatives, based on at least one diene elastomer, one inorganic filler as reinforcing filler and one blocked mercaptosilane corresponding to the general formula (I):
(R²O)ₐR¹₍₃₋ₐ₎Si—Z—S—C(═O)-A
wherein:
the symbols R¹, which are identical or different, each represent a monovalent hydrocarbon group chosen from linear or branched alkyls, cycloalkyls or aryls having from 1 to 18 carbon atoms;
the symbols R², which are identical or different, each represent hydrogen or a monovalent hydrocarbon group chosen from linear or branched alkyls, cycloalkyls or aryls having from 1 to 18 carbon atoms;
the symbol A represents hydrogen or a monovalent hydrocarbon group chosen from linear or branched alkyls, cycloalkyls or aryls having from 1 to 18 carbon atoms and linear or branched alkoxyalkyls having from 2 to 8 carbon atoms;
the symbol Z represents a divalent bonding group comprising from 1 to 18 carbon atoms;
a is an integer equal to 1, 2 or 3.

2) The rubber composition according to claim 1, wherein Z comprises one or more heteroatoms selected from the group consisting of O, S and N.

3) The rubber composition according to claim 1, wherein a is equal to 3 and at least one of the R² symbols represents a monovalent hydrocarbon group chosen from linear or branched alkyls, cycloalkyls or aryls having from 1 to 18 carbon atoms.

4) The rubber composition according to claim 1, wherein the R² symbols represent a monovalent hydrocarbon group chosen from linear or branched alkyls, cycloalkyls or aryls having from 1 to 18 carbon atoms.

5) The rubber composition according to claim 4, wherein the following characteristics are adhered to:
the R¹ and R² symbols are selected from the group consisting of methyl, ethyl, n-propyl and isopropyl;
the A symbol is selected from the group consisting of alkyls having from 1 to 18 carbon atoms and the phenyl radical;
the Z symbol is selected from the group consisting of C₁-C₁₈ alkylenes and C₆-C₁₂ arylenes.

6) The rubber composition according to claim 5, Z is chosen from C₁-C₁₀ alkylenes.

7) The rubber composition according to claim 6, wherein R¹ and R² are ethyls, A is a heptyl and Z is a propylene.

8) The rubber composition according to claim 4, wherein a is equal to 1.

9) The rubber composition according to claim 8, wherein:
the R¹ symbols are chosen from methyl, ethyl, n-propyl and isopropyl;
R² is chosen from methyl and ethyl,
A is chosen from alkyls having from 1 to 18 carbon atoms and the phenyl radical,
Z is chosen from C₁-C₁₈ alkylenes and C₆-C₁₂ arylenes.

10) The rubber composition according to claim 9, wherein Z is chosen from C₁-C₁₀ alkylenes.

11) The rubber composition according to claim 10, wherein Z is chosen from C₁-C₄ alkylenes.

12) The rubber composition according to claim 9, wherein the R¹ symbols are methyls.

13) The rubber composition according to claim 9, wherein A is chosen from alkyls having from 1 to 7 carbon atoms and the phenyl radical.

14) The rubber composition according to claim 9, in which the R¹ symbols are methyls, A is a heptyl, R² is ethyl and Z is a propylene.

15) The rubber composition according to claim 1, wherein the R² symbol represents hydrogen.

16) The rubber composition according to claim 15, wherein a is equal to 2.

17) The rubber composition according to claim 15, wherein a is equal to 1.

18) The rubber composition according to claim 15, wherein:
R¹ is chosen from methyl, ethyl, n-propyl and isopropyl, preferably from methyl and ethyl;
A is chosen from alkyls having from 1 to 18 carbon atoms and the phenyl radical;
Z is chosen from C₁-C₁₈ alkylenes and C₆-C₁₂ arylenes; and
a is equal to 1 or 2.

19) The rubber composition according to claim 18, wherein Z is chosen from C₁-C₁₀ alkylenes.

20) The rubber composition according to claim 19, wherein Z is chosen from C₁-C₄ alkylenes.

21) The rubber composition according to claim 18, wherein R¹ is a methyl.

22) The rubber composition according to claim 18, wherein A is chosen from alkyls having from 1 to 7 carbon atoms and the phenyl radical.

23). The rubber composition according to claim 18, wherein R¹ is a-methyl, Z is a propylene and A is a heptyl.

24) The rubber composition according to claim 1, wherein the diene elastomer is selected from the group consisting of polybutadienes, synthetic polyisoprenes, natural rubber, butadiene copolymers, isoprene copolymers and the mixtures of these elastomers.

25) The rubber composition according to claim 1, wherein the reinforcing inorganic filler is the predominant reinforcing filler.

26) The rubber composition according to claim 1, wherein the reinforcing inorganic filler is a siliceous or aluminous filler.

27) The rubber composition according to claim 1, wherein the amount of reinforcing inorganic filler is greater than 50 phr.

28) The rubber composition according to claim 1, wherein the content of coupling agent represents between 2% and 20% by weight, with respect to the amount of reinforcing inorganic filler.

29) The rubber composition according to claim 1, wherein the content of coupling agent is between 2 and 15 phr.

30) A finished or semi-finished article comprising a rubber composition according to claim 1.

31) A tire tread comprising a rubber composition according to claim 1.

32) A tire or semi-finished product comprising at least one rubber composition according to claim 1.
